(19) United States
(12) Patent Application Publication
(10) Pub. No.: US 2019/0152301 A1
(43) Pub. Date: May 23, 2019

(54) LIGHT EMITTING SYSTEM AND METHOD OF ATTACHING LIGHT EMITTING DEVICE TO BASE MEMBER

(71) Applicant: PIONEER CORPORATION, Bunkyo-ku, Tokyo (JP)

(72) Inventor: Akira HIRASAWA, Tokyo (JP)

(21) Appl. No.: 16/300,217

(22) PCT Filed: May 11, 2016
(86) PCT No.: PCT/JP2016/063999

§ 371 Date: Nov. 9, 2018

(51) Int. Cl. B60J 1/20; B60Q 1/30; B60Q 1/26; F21S 43/00; B32B 17/10

(52) U.S. Cl. CPC B60J 1/2008; B60Q 1/30; B32B 17/10036; F21S 43/00; B60Q 1/268

(57) ABSTRACT

A light emitting system includes a light emitting device (140), a base member (200) and a plurality of heating wires (300). The base member (200) has a light transmitting property. Each heating wire (300) is on the inner surface (202) of the base member (200). The plurality of heating wires (300) includes a heating wire (302) and a heating wire (304). The heating wire (304) is adjacent to the heating wire (302). The light emitting device (140) is on an inner surface (202) of the base member (200). The light emitting device (140) includes a light emitting portion (142) and a light transmitting portion (144). The light emitting portion (142) is between the heating wire (302) and the heating wire (304). The light emitting portion (142) does not overlap with the heating wire (302) and the heating wire (304) in the thickness direction of the base member (200).

### TECHNICAL FIELD

The present invention relates to a light emitting system and a method of attaching the light emitting device to a base member.

### BACKGROUND ART

In recent years, as described in Patent Document 1, a light emitting device having a light transmitting property may be attached to the rear window of a vehicle, for example. The rear window of the vehicle may be provided with a heating wire (defogger). In Patent Document 2 describes that a light emitting device (for example, an organic light emitting diode (OLED)) overlaps with a heating wire. In Patent Document 2, the electric power of the light emitting device is supplied from the heating wire.

### RELATED DOCUMENT

### Patent Document

[Patent Document 1] Japanese Unexamined Patent Publication No. 2015-220026

[Patent Document 2] Japanese Unexamined Patent Publication No. 2014-008877

### SUMMARY OF THE INVENTION

As described in Patent Document 2, the light emitting device may be located near the heating wire. The inventors have found that the light emitting device may be degraded by heat generated from the heating wire.

An object of the invention is to reduce degradation of a light emitting portion caused by a heating wire, for example.

### Means for Solving the Problem

The invention according to claim 1 is a light emitting system comprising:

a base member having a light transmitting property;

a first heating wire over a surface of or inside the base member; and

a first light emitting element over the surface of or inside the base member, the first light emitting element including a light emitting portion and a light transmitting portion,

wherein the light emitting portion does not overlap with the first heating wire in a thickness direction of the base member.

The invention according to claim 10 is a light emitting system comprising:

a base member having a light transmitting property;

a first heating wire over a surface of or inside the base member;

a second heating wire adjacent to the first heating wire over the surface of or inside the base member; and

a first light emitting element over the surface of or inside the base member, the first light emitting element including a light emitting portion and a light transmitting portion,

wherein the light emitting portion is between the first heating wire and the second heating wire, and does not overlap with the first heating wire and the second heating wire in a thickness direction of the base member.

The invention according to claim 11 is a method of attaching a light emitting device including a light emitting portion and a light transmitting portion to a light-transmitting base member including a first heating wire, the method comprising:

attaching the light emitting device to the base member such that the light emitting portion and the first heating wire do not overlap with each other in a thickness direction of the base member.

### BRIEF DESCRIPTION OF THE DRAWINGS

The above objects and other objects, features, and advantages will become more apparent from the following description of the preferred embodiments and the accompanying drawings.

FIG. 1 is a plan view illustrating a light emitting system according to an embodiment.

FIG. 2 is an enlarged view of a in FIG. 1.

FIG. 3 is a cross-sectional view taken along line A-A of FIG. 2.

FIG. 4 is a view illustrating a first Modification Example of FIG. 3.

FIG. 5 is a view illustrating a second Modification Example of FIG. 3.

FIG. 6 is a view illustrating a third Modification Example of FIG. 3.

FIG. 7 is a view illustrating a fourth Modification Example of FIG. 3.

FIG. 8 is a view illustrating a first Modification Example of FIG. 1.

FIG. 9 is a view illustrating a second Modification Example of FIG. 1.

FIG. 10 is a view illustrating a third Modification Example of FIG. 1.

FIG. 11 is an enlarged view of a in FIG. 10.

FIG. 12 is a view illustrating a fourth Modification Example of FIG. 1.

FIG. 13 is a view illustrating a fifth Modification Example of FIG. 1.

FIG. 14 is a view illustrating a sixth Modification Example of FIG. 1.

FIG. 15 is a view illustrating a seventh Modification Example of FIG. 1.

FIG. 16 is an enlarged view of a in FIG. 15.

FIG. 17 is a cross-sectional view taken along line A-A of FIG. 16.

FIG. 18 is a plan view illustrating a light emitting device used in a light emitting system according to an example.

FIG. 19 is a cross-sectional view taken along line A-A of FIG. 18.

### DESCRIPTION OF EMBODIMENTS

Hereinafter, embodiments of the present invention will be described with reference to the drawings. In all the drawings, the similar components are denoted by the similar reference numerals, and a description thereof will be appropriately not repeated.

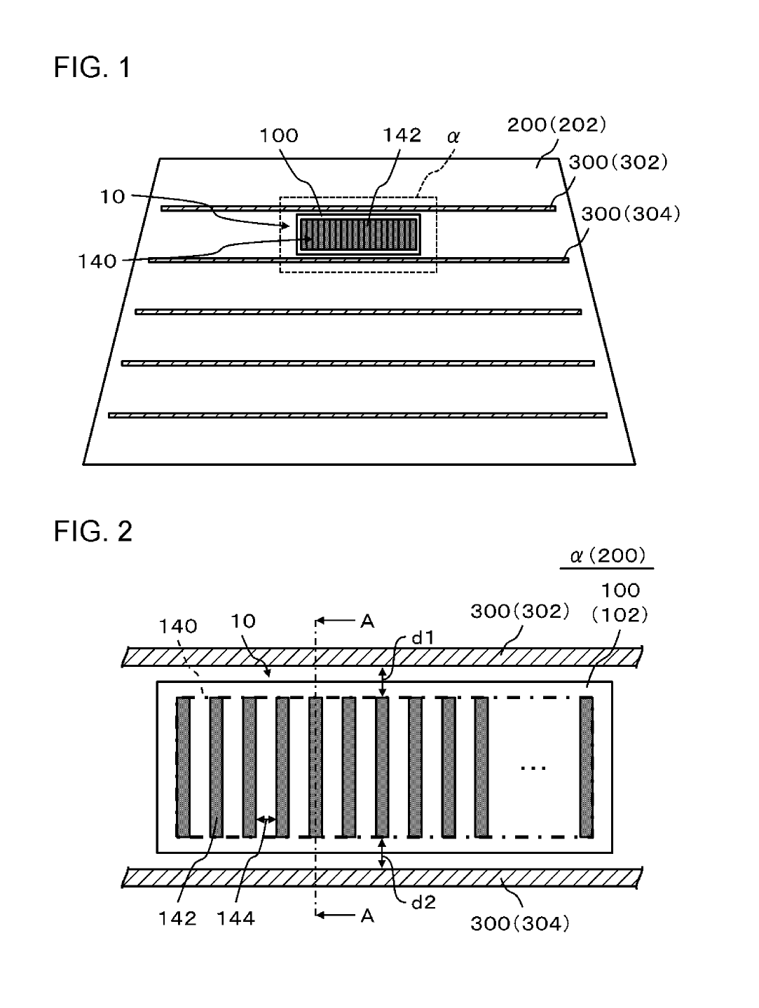

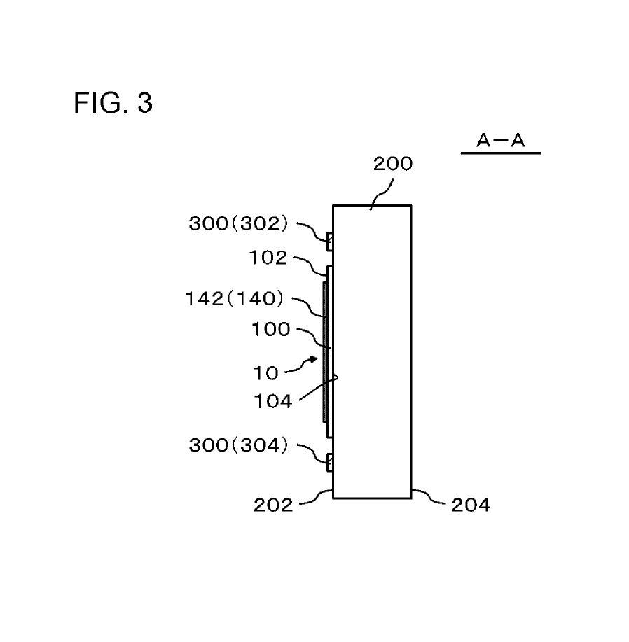

FIG. 1 is a plan view illustrating a light emitting system according to an embodiment. FIG. 2 is an enlarged view of a in FIG. 1. FIG. 3 is a cross-sectional view taken along line A-A of FIG. 2. The light emitting system includes alight emitting element 140, abase member 200 and a plurality of heating wires 300. The base member 200 has a light transmitting property. Each heating wire 300 is on the surface (inner surface) 202 of the base member 200. The plurality of heating wires 300 includes a heating wire (a first heating wire) 302 and a heating wire (a second heating wire) 304. The heating wire 304 is adjacent to the heating wire 302. In other words, no other heating wire 300 is located between the heating wire 302 and the heating wire 304. The light emitting element 140 is on the surface (inner surface) 202 of the base member 200. The light emitting element 140 includes a light emitting portion 142 and a light transmitting portion 144. The light emitting portion 142 is in the vicinity of the heating wire 302 and the heating wire 304, specifically between the heating wire 302 and the heating wire 304. The light emitting portion 142 does not overlap with the heating wire 302 and the heating wire 304 in the thickness direction of the base member 200. Detailed explanation will follow.

The light emitting system includes a light emitting element 140 and a base member 200. The light emitting element 140 includes a light emitting portion 142, a light transmitting portion 144, and may further include a substrate 100.

In the present embodiment, the base member 200 is mounted on a moving object such as a vehicle, and specifically is a rear window of the vehicle. In other words, the base member 200 includes glass. The base member 200 has an inner surface 202 and an outer surface 204. The inner surface 202 faces the inside of the vehicle. The outer surface 204 faces the outside of the vehicle. However, the base member 200 is not limited to the rear window of the vehicle. For example, the base member 200 may be a front window or a side window of the vehicle. Furthermore, the base member 200 may be a window of a moving object other than the vehicle (for example, a train or an airplane). Hereinafter, description will be given on the assumption that the base member 200 is a rear window of the vehicle. When the light emitting system is thus formed in a moving object, it can emit light without hindering the visibility of a person (especially a driver of the moving object) inside the moving object to the outside of the moving object.

The substrate 100 has a first surface 102 and a second surface 104. The second surface 104 is opposite to the first surface 102 and is a back surface of the substrate 100. In the example shown in FIG. 2, the first surface 102 is a rectangle. However, the shape of the first surface 102 may be a shape other than a rectangular shape. The substrate 100 has a light transmitting property and is configured to include glass or resin, for example. When the base member 200 has a curved surface and the substrate 100 has flexibility, the substrate 100 can be conformed to the curved surface of the base member 200, to thereby reduce the space between the substrate 100 and the base member 200. When this space is reduced, light propagation can be prevented between the base member 200 and the substrate 100, and the light emission of the light emitting portion 142 can be efficiently extracted outside the light emitting system. When the substrate 100 has flexibility, the flexibility may be provided by forming the substrate 100 with a glass with a thickness less than or equal to 500 μm, or by forming the substrate 100 to include a resin material.

The light emitting portion 142 and the light transmitting portion 144 are on the first surface 102 of the substrates 100. An area of the semi-transmissive light emitting region in the light emitting element 140, which is a combination of the region where the light emitting portion 142 emits light (light emitting region), and the region transmitting light where the light transmitting portion 144 is located (light transmitting region), is smaller than an area of the first surface 102 of the substrate 100, and any part of the light emitting region and the light transmitting region is positioned inside the first surface 102 of the substrate 100. Here, when the light emitting portions 142 are formed in a stripe shape, the light emitting regions of the light emitting portions 142 located at the outermost sides and the region between the light emitting portions 142 are referred to as the semi-transmissive light emitting region of the light emitting element 140 or the light emitting system. In the example shown in FIG. 3, the substrate 100 is attached to the base member 200 such that the second surface 104 faces the inner surface 202 of the base member 200. In other words, in the example shown in FIG. 3, the light emitting device 10 is inside the moving object.

The light emitting element 140 has a plurality of light emitting portions 142 and a plurality of light transmitting portions 144. The plurality of light emitting portions 142 and the plurality of light transmitting portions 144 are alternately arranged in a row. The shape of each light emitting portion 142 is a rectangular having a pair of long sides and a pair of short sides. In the example shown in FIGS. 1 and 2, the long sides of the light emitting portions 142 extend in a direction intersecting (specifically, perpendicular to) the row direction of the plurality of light emitting portions 142. In other words, the plurality of light emitting portions 142 is arranged in a stripe shape. It should be noted that the width of the light transmitting portion 144 (that is, the interval between adjacent light emitting portions 142) is less than 2 mm, for example.

In the example shown in FIG. 2, the shape of the light emitting element 140 is specified as a rectangle having a pair of long sides and a pair of short sides. More specifically, the long sides of the light emitting element 140 overlap with the short sides of the plurality of light emitting portions 142. One short side of the light emitting element 140 overlaps with an outer long side of the four sides of the light emitting portion 142 at one end of the plurality of light emitting portions 142. The other short side of the light emitting element 140 overlaps with the outer long side of the four sides of the light emitting portion 142 at the other end of the plurality of light emitting portions 142.

In the example shown in FIGS. 1 to 3, the light emitting device 10 is a semi-transmissive OLED. Most of the light from the light emitting portion 142 is emitted from the second surface 104 side, and light from the light emitting portion 142 is hardly emitted from the first surface 102 side. Thus, light from light emitting portion 142 or light emitting element 140 is emitted toward outside the vehicle. When light is emitted from the light emitting element 140, human vision perceives as if the light is emitted throughout the entire surface of the light emitting element 140 from the second surface 104 side of the substrate 100. When light is not emitted from the light emitting element 140, human vision perceives that an object on the first surface 102 side of the substrate 100 is seen through from the second surface 104 side of the substrate 100. An object on the second surface 104 side of the substrate 100 may be seen through from the first surface 102 of the substrate 100 regardless of whether or not the light emitting device 10, the light emitting element 140, or the light emitting portion 142 emits light.

A plurality of heating wires 300 is arranged in parallel to each other in a row. The heating wire 300 is a nichrome wire, for example. The heating wire 300 emits a heat by electric resistance. In the example shown in FIG. 3, the heating wire 300 is on an inner surface 202 of the base member 200. In other words, in the example shown in FIG. 3, the heating wire 300 is inside the vehicle.

In the example shown in FIGS. 1 and 2, a plurality of light emitting portions 142 is arranged in a direction intersecting the row direction of a plurality of heating wires 300 (in the example shown in FIG. 2, a direction from the heating wire 302 side to the heating wire 304 side). In other words, the plurality of light emitting portions 142 is arranged in an extending direction of the heating wire 300. In the thickness direction of the base member 200, none of the plurality of light emitting portions 142 overlaps with the heating wire 300. All of the plurality of light emitting portions 142 are between heating wire 302 and heating wire 304. Further, in the example shown in FIG. 2, in the thickness direction of the base member 200, none of the parts of the substrate 100 overlaps with the heating wire 300. However, a part of the substrate 100 (for example, the edge of the substrate 100) may overlap with the heating wire 300.

In the example shown in FIG. 2, the light emitting element 140 is in the vicinity of heating wire 302 and heating wire 304. Specifically, the heating wire 302 and the light emitting element 140 (light emitting portion 142) are spaced apart by a distance d1. The heating wire 304 and the light emitting element 140 (light emitting portion 142) are spaced apart by a distance d2. In the example shown in FIG. 2, the distance d1 and the distance d2 are equal to each other. However, the distance d1 and the distance d2 may be different from each other. The distances d1 and d2 are preferably greater than or equal to 1 mm and less than or equal to 10 mm, for example. If the distances d1 and d2 are greater than or equal to 1 mm, the interval between the light emitting portion 142 and the heating wire 300 is sufficiently wide. If the distances d1 and d2 are less than or equal to 10 mm, the length of the light emitting portion 142 (the long side of the light emitting portion 142) is sufficiently long.

As described above, according to the present embodiment, the light emitting portion 142 and the heating wire 300 do not overlap with each other in the thickness direction of the base member 200. This can reduce degradation of the light emitting portion 142 caused by the heating wire 300. Specifically, if the light emitting portion 142 and the heating wire 300 were overlapped with each other, the heat from the heating wire 300 would be likely to be transmitted to the light emitting portion 142. In contrast, in the present embodiment, as described above, the light emitting portion 142 and the heating wire 300 do not overlap with each other. Accordingly, the heat from the heating wire 300 is less likely to be transmitted to the light emitting portion 142. This can reduce the degradation of the light emitting portion 142 caused by the heating wire 300.

Furthermore, in the present embodiment, degradation of the light emitting portion 142 caused by the heating wire 300 can be reduced even when the light emitting portion 142 and the heating wire 300 are not shifted apart from each other in the thickness direction of the base member 200. Specifically, the farther away the light emitting portion 142 and the heating wire 300 are from each other in the thickness direction of the base member 200, the less likely the heat from the heating wire 300 is transmitted to the light emitting portion 142. In contrast, in this embodiment, the light emitting portion 142 and the heating wire 300 are located at almost the same height (that is, on the inner surface 202 of the base member 200) in the thickness direction of the base member 200. Even in such a case, in this embodiment, the light emitting portion 142 and the heating wire 300 do not overlap with each other in the thickness direction of the base member 200. Accordingly, the heat from the heating wire 300 is less likely to be transmitted to the light emitting portion 142. This can reduce the degradation of the light emitting portion 142 caused by the heating wire 300.

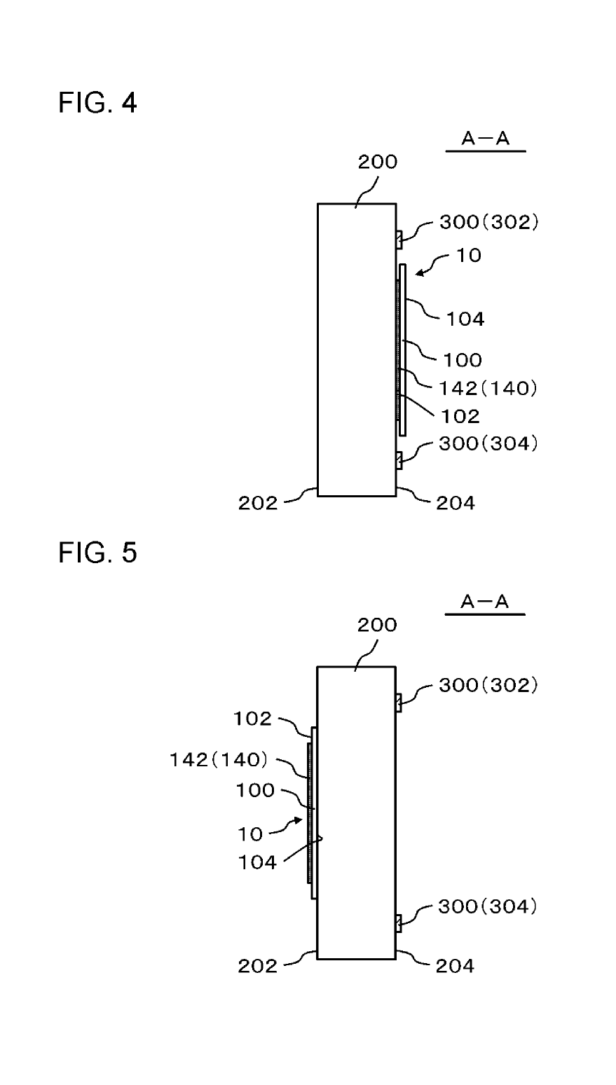

FIG. 4 is a view illustrating a first Modification Example of FIG. 3. As shown in this figure, the light emitting device 10 and the heating wire 300 may be on the outer surface 204 of the base member 200. In other words, in the example shown in this figure, the light emitting device 10 and the heating wire 300 are outside the vehicle. The light emitting device 10 is attached to the base member 200 such that the first surface 102 (the light emitting portion 142) of the substrate 100 faces the outer surface 204 of the base member 200. Most of the light from the light emitting portion 142 is emitted from the second surface 104 side, and light from the light emitting portion 142 is hardly emitted from the first surface 102 side. Thus, the light from the light emitting element 140 is emitted toward outside the vehicle.

In the example shown in this figure, degradation of the light emitting portion 142 caused by the heating wire 300 can be reduced even when the light emitting portion 142 and the heating wire 300 are not shifted apart from each other in the thickness direction of the base member 200. Specifically, the farther away the light emitting portion 142 and the heating wire 300 are from each other in the thickness direction of the base member 200, the less likely the heat from the heating wire 300 is transmitted to the light emitting portion 142. In contrast, in the example shown in this figure, the light emitting portion 142 and the heating wire 300 are located at almost the same height (that is, on the outer surface 204 of the base member 200) in the thickness direction of the base member 200. Even in such a case, in the example shown in this figure, the light emitting portion 142 and the heating wire 300 do not overlap with each other in the thickness direction of the base member 200. Accordingly, the heat from the heating wire 300 is less likely to be transmitted to the light emitting portion 142. This can reduce the degradation of the light emitting portion 142 caused by the heating wire 300.

FIG. 5 is a view illustrating a second Modification Example of FIG. 3. As shown in this figure, the light emitting device 10 and the heating wire 300 may be located opposite to each other across the base member 200. Specifically, the light emitting device 10 is on the inner surface 202 of the base member 200 and the heating wire 300 is on the outer surface 204 of the base member 200. In other words, the light emitting device 10 is inside the vehicle and the heating wire 300 is outside the vehicle. The light emitting device 10 is attached to the base member 200 such that the second surface 104 of the substrate 100 faces the inner surface 202 of the base member 200. Most of the light from the light emitting portion 142 is emitted from the second surface 104 side, and light from the light emitting portion 142 is hardly emitted from the first surface 102 side. Thus, the light from the light emitting element 140 is emitted toward outside the vehicle.

In the example shown in this figure, the base member 200 is located between the heating wire 300 and the light emitting portion 142. Accordingly, the heat from the heating wire 300 to the light emitting portion 142 can be blocked by the base member 200.

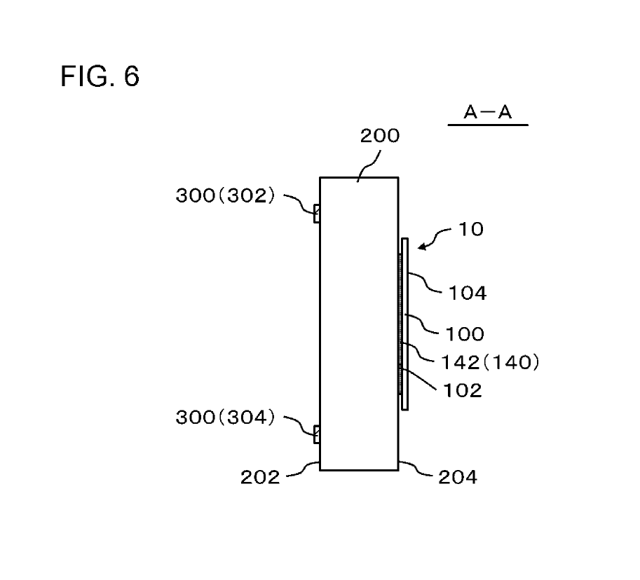

FIG. 6 is a view illustrating a third Modification Example of FIG. 3. As shown in this figure, the light emitting device 10 and the heating wire 300 may be located opposite to each other across the base member 200. Specifically, the light emitting device 10 is on the outer surface 204 of the base member 200 and the heating wire 300 is on the inner surface 202 of the base member 200. In other words, the light emitting device 10 is outside the vehicle and the heating wire 300 is inside the vehicle. The light emitting device 10 is attached to the base member 200 such that the first surface 102 (the light emitting portion 142) of the substrate 100 faces the outer surface 204 of the base member 200. Most of the light from the light emitting portion 142 is emitted from the second surface 104 side, and light from the light emitting portion 142 is hardly emitted from the first surface 102 side. Thus, the light from the light emitting element 140 is emitted toward outside the vehicle.

In the example shown in this figure, the base member 200 is located between the heating wire 300 and the light emitting portion 142. Accordingly, the heat from the heating wire 300 to the light emitting portion 142 can be blocked by the base member 200.

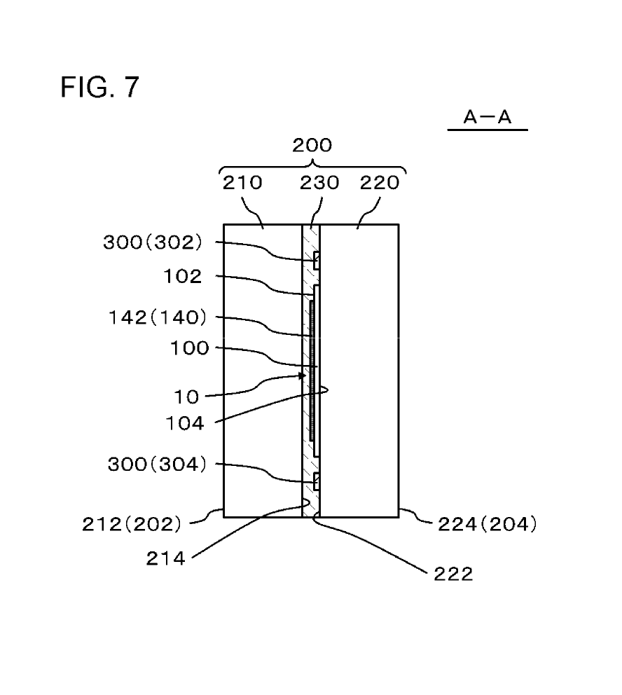

FIG. 7 is a view illustrating a fourth Modification Example of FIG. 3. As shown in this figure, the light emitting device 10 and the heating wire 300 may be inside the base member 200. The base member 200 is a laminated glass. Specifically, the base member 200 has a first base member 210, a second base member 220, and an intermediate layer 230. The first base member 210 has a surface 212 and a surface 214. The surface 212 serves as the inner surface 202 of the base member 200. The surface 214 is opposite to the surface 212. The second base member 220 has a surface 222 and a surface 224. The surface 224 is opposite to the surface 222 and serves as the outer surface 204 of the base member 200. The intermediate layer 230 is a resin layer, for example. The first base member 210 and the second base member 220 are bonded to each other through the intermediate layer 230 such that the surface 214 of the first base member 210 and the surface 222 of the second base member 220 face each other across the intermediate layer 230.

In the example shown in this figure, the light emitting device 10 and the heating wire 300 are attached to the surface 222 of the base member 200 and covered by the intermediate layer 230. The light emitting device 10 is attached to the second base member 220 such that the second surface 104 of the substrate 100 faces the surface 222 of the second base member 220. The light emitting device 10 and the heating wire 300 may be attached to the surface 214 of the first base member 210. Most of the light from the light emitting portion 142 is emitted from the second surface 104 side, and light from the light emitting portion 142 is hardly emitted from the first surface 102 side. Thus, the light from the light emitting element 140 is emitted toward outside the vehicle.

In the example shown in this figure, degradation of the light emitting portion 142 caused by the heating wire 300 can be reduced even when the light emitting portion 142 and the heating wire 300 are not shifted from each other in the thickness direction of the base member 200. Specifically, the farther away the light emitting portion 142 and the heating wire 300 are from each other in the thickness direction of the base member 200, the less likely the heat from the heating wire 300 is transmitted to the light emitting portion 142. In contrast, in the example shown in this figure, the light emitting portion 142 and the heating wire 300 are located at almost the same height (that is, between the first base member 210 and the second base member 220) in the thickness direction of the base member 200. Even in such a case, in the example shown in this figure, the light emitting portion 142 and the heating wire 300 do not overlap with each other in the thickness direction of the base member 200. Accordingly, the heat from the heating wire 300 is less likely to be transmitted to the light emitting portion 142. This can reduce the degradation of the light emitting portion 142 caused by the heating wire 300.

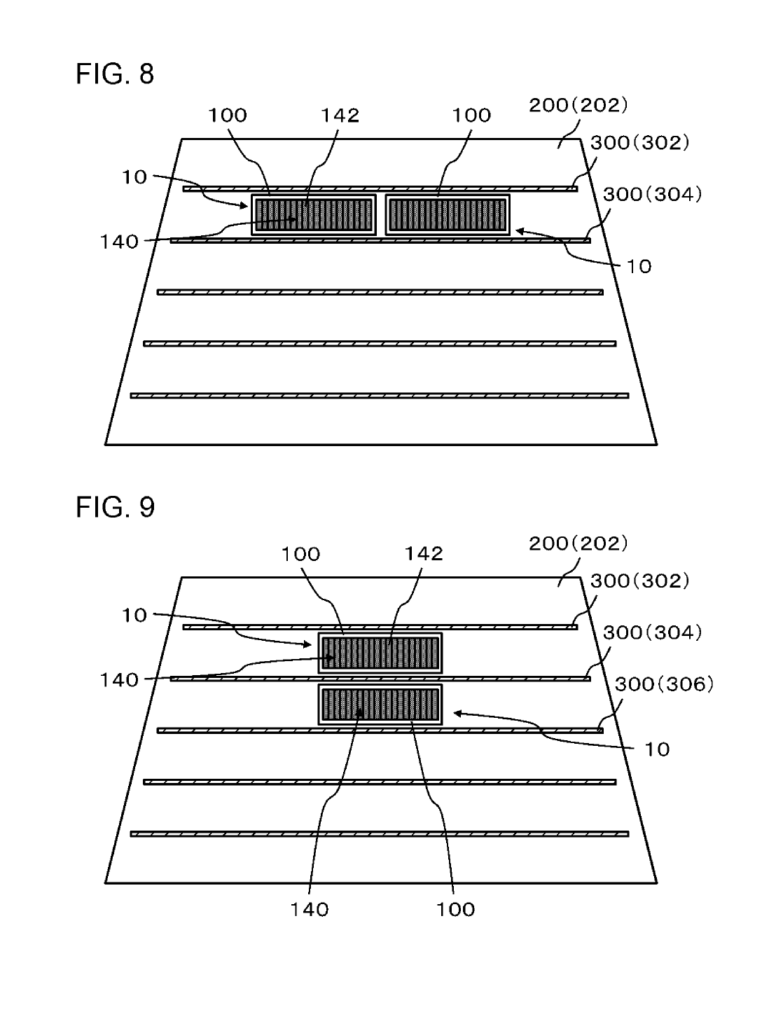

FIG. 8 is a view illustrating a first Modification Example of FIG. 1. As shown in this figure, a plurality of light emitting devices 10, that is, a plurality of substrates 100 may be arranged in the extending direction of the heating wire 300. Thus, the plurality of light emitting elements 140 is arranged in the extending direction of the heating wire 300. Each substrate 100 is between the heating wire 302 and the heating wire 304 and does not overlap with the heating wire 302 and the heating wire 304 in the thickness direction of the base member 200. Also in the example shown in this figure, the light emitting element 140 (light emitting portion 142) does not overlap with the heating wire 300 in the thickness direction of the base member 200.

FIG. 9 is a view illustrating a second Modification Example of FIG. 1. As shown in this figure, a plurality of light emitting devices 10, that is, a plurality of substrates 100 may be arranged in the row direction of a plurality of heating wires 300. Thus, the plurality of light emitting elements 140 is arranged in the row direction of the plurality of heating wires 300. More specifically, the plurality of heating wires 300 includes a heating wire 302, a heating wire 304, and a heating wire 306. The heating wire 304 is adjacent to the heating wire 302 and the heating wire 306 is adjacent to the heating wire 304. The light emitting devices 10 adjacent to each other are arranged such that the substrate 100 (light emitting element 140) of one light emitting device 10 and the substrate 100 of the other light emitting device 10 are located opposite to each other across the heating wire 304. Also in the example shown in this figure, the light emitting element 140 (light emitting portion 142) does not overlap with the heating wire 300 in the thickness direction of the base member 200.

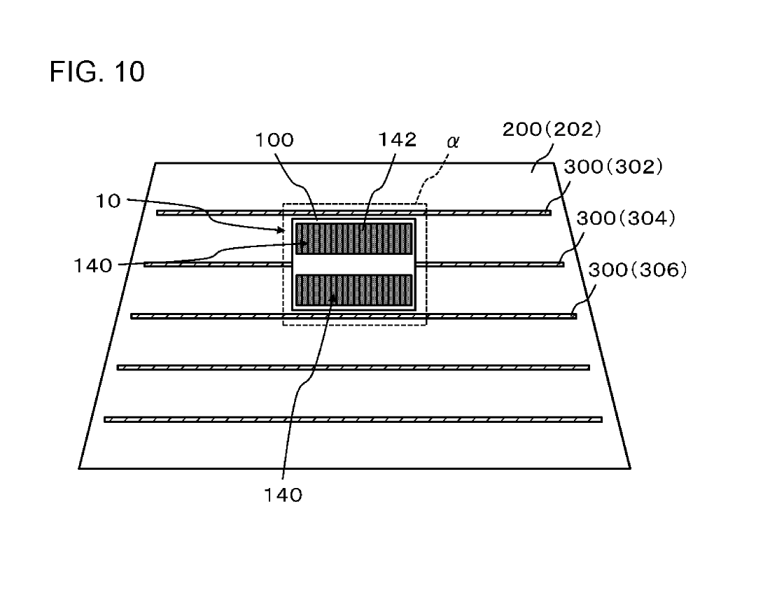

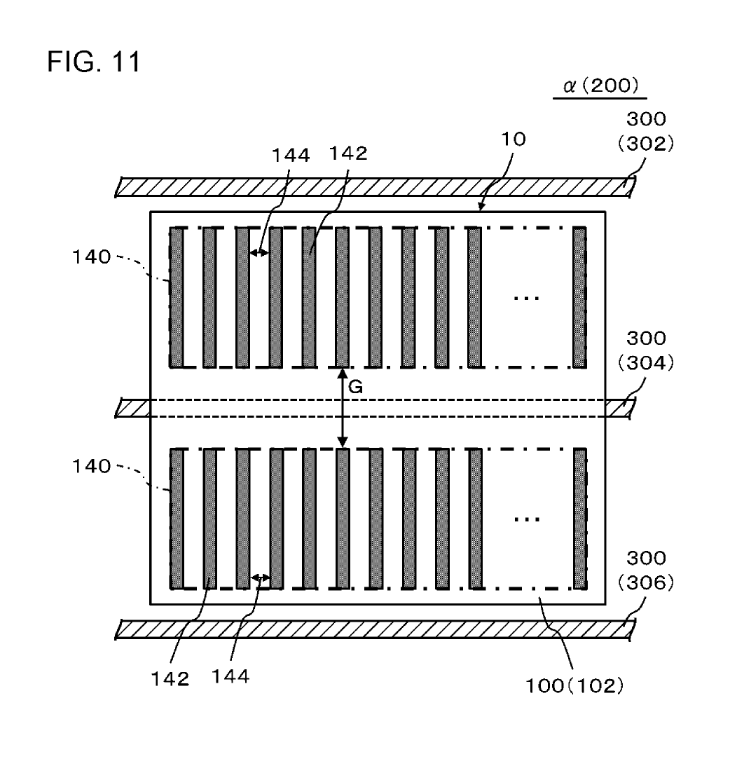

FIG. 10 is a view illustrating a third Modification Example of FIG. 1. FIG. 11 is an enlarged view of a in FIG. 10. In this Modification Example, the light emitting device 10 has a substrate 100 and a plurality of light emitting elements 140. The plurality of light emitting elements 140 is arranged in the row direction of the plurality of heating wires 300 on the first surface 102 of the substrate 100. More specifically, the substrate 100 is between the heating wire 302 and the heating wire 306 and overlaps with the heating wire 304. The adjacent light emitting elements 140 are arranged such that one light emitting element 140 and the other light emitting element 140 are located opposite to each other across the heating wire 304. Also in this Modification Example, the light emitting element 140 (light emitting portion 142) does not overlap with the heating wire 300 in the thickness direction of the base member 200.

In the example shown in FIG. 11, the light emitting elements 140 adjacent to each other are spaced apart by a distance G. The distance G is wider than the width of light transmitting portion 144 (that is, the interval between light emitting portions 142 adjacent to each other), and is greater than or equal to 2 mm, for example. In other words, in an example shown in FIG. 11, the light emitting portions 142 adjacent to each other with a wider interval than the width of the light transmitting portion 144 belong to different light emitting elements 140.

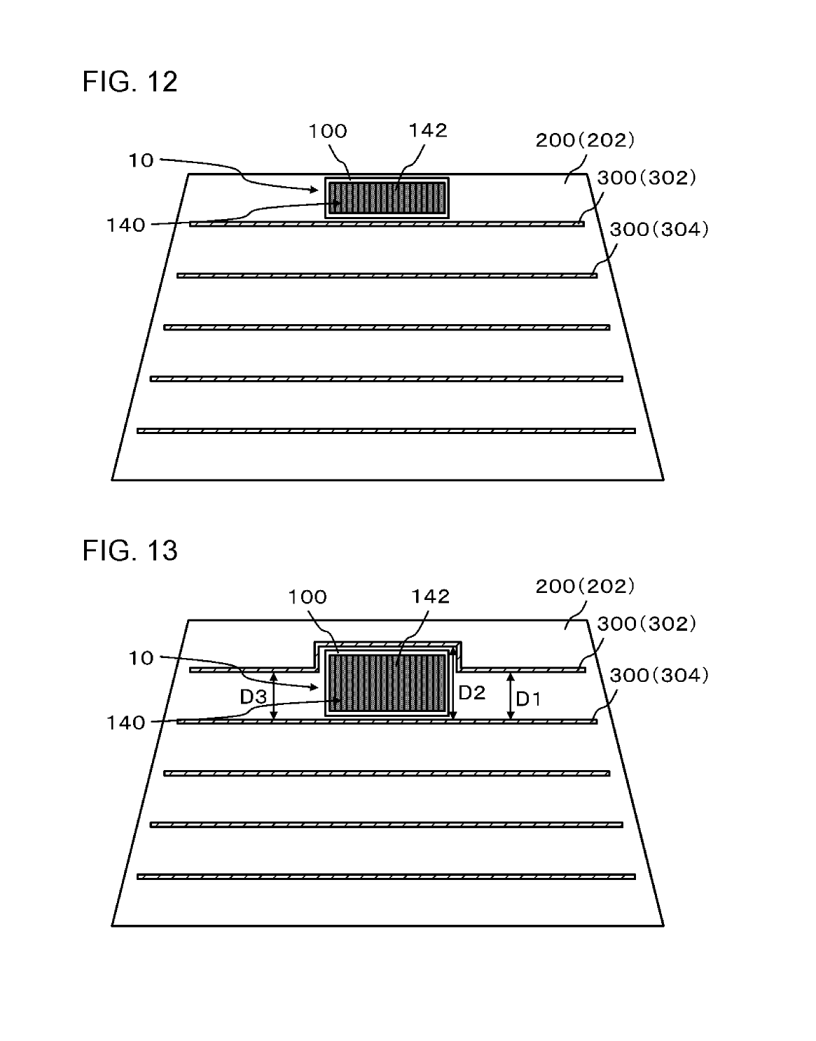

FIG. 12 is a view illustrating a fourth Modification Example of FIG. 1. As shown in this figure, the light emitting device 10, that is, the substrate 100 may not be located between heating wires 300 adjacent to each other (for example, between a heating wire 302 and a heating wire 304). In the example shown in this figure, the light emitting device 10, that is, the substrate 100 is located outside the heating wire 300 at one end of the plurality of heating wires 300 (heating wire 302), and between the heating wire 302 and the edge of the base member 200. Also in the example shown in this figure, the light emitting element 140 (light emitting portion 142) does not overlap with the heating wire 300 in the thickness direction of the base member 200.

FIG. 13 is a view illustrating a fifth Modification Example of FIG. 1. In the example shown in this figure, the heating wire 302 includes a first portion distanced away from the heating wire 304 by a first distance D1, a second portion away from the heating wire 304 by a second distance D2, and a third portion distanced away from the heating wire 304 by a third distance D3. The second portion of the heating wire 302 is between the first portion of the heating wire 302 and the third portion of the heating wire 302. The second distance D2 is greater than both of the first distance D1 and the third distance D3. The first distance D1 and the third distance D3 may be equal to each other or different from each other.

The light emitting device 10, that is, the substrate 100 is between the second portion of the heating wire 302 and the heating wire 304. In the direction from the heating wire 302 to the heating wire 304, the length of the light emitting portion 142 is greater than both the first distance D1 and the third distance D3. Also in the example shown in this figure, the light emitting element 140 (light emitting portion 142) does not overlap with the heating wire 300 in the thickness direction of the base member 200.

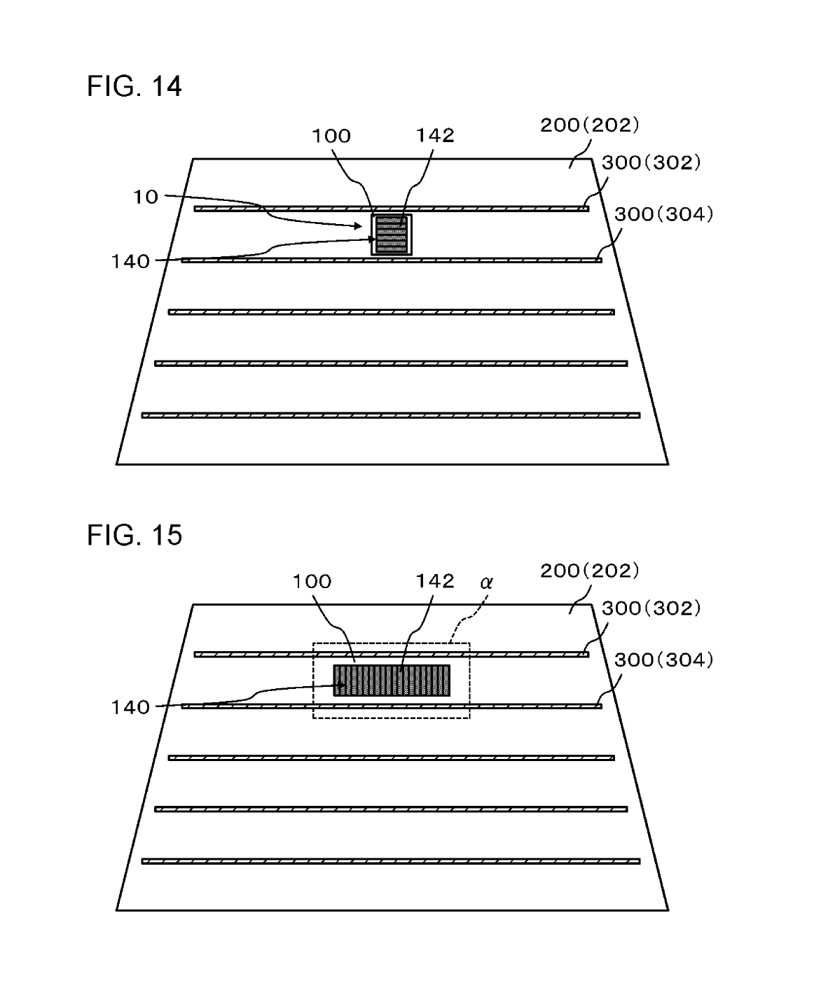

FIG. 14 is a view illustrating a sixth Modification Example of FIG. 1. As shown in this figure, a plurality of light emitting portions 142 may be arranged in the row direction of the plurality of heating wires 300 (a direction from the heating wire 302 side to the heating wire 304 side). The light emitting device 10, that is, the substrate 100 is between the heating wire 302 and the heating wire 304. Also in the example shown in this figure, the light emitting element 140 (light emitting portion 142) does not overlap with the heating wire 300 in the thickness direction of the base member 200.

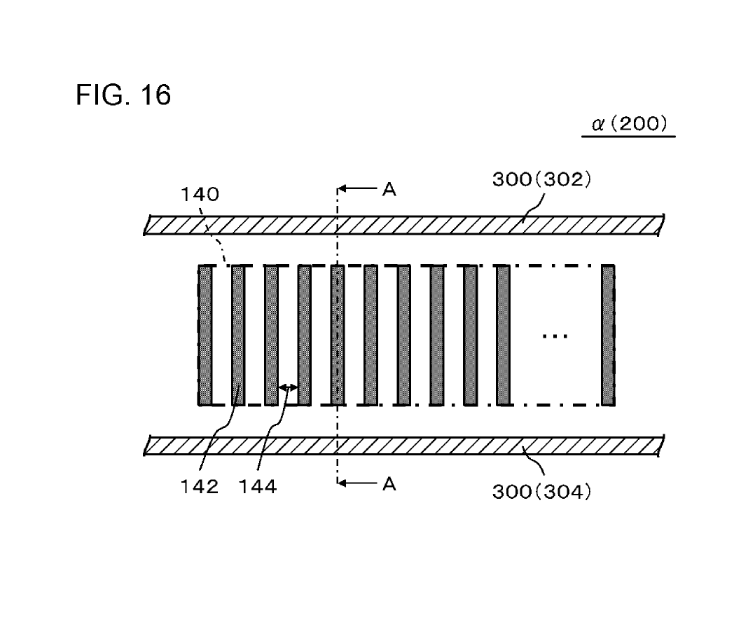

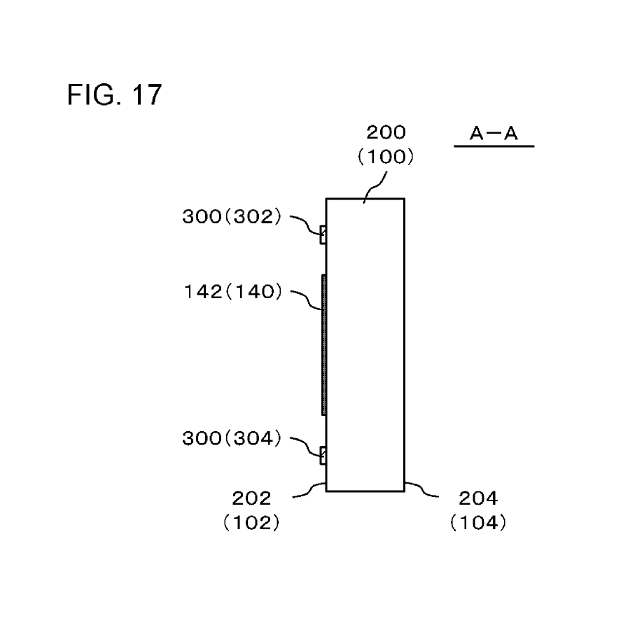

FIG. 15 is a view illustrating a seventh Modification Example of FIG. 1. FIG. 16 is an enlarged view of a in FIG. 15. FIG. 17 is a cross-sectional view taken along line A-A of FIG. 16. In this Modification Example, a light emitting element 140 (that is, a plurality of light emitting portions 142) is on the inner surface 202 of the base member 200 without the substrate 100 (for example, FIGS. 1 to 3). In other words, in this Modification Example, base member 200 serves as substrate 100. Most of the light from the light emitting portion 142 is emitted from the outer surface 204 side of the base member 200 (the second surface 104 of the substrate 100), and the light from the light emitting portion 142 is hardly emitted from the inner surface 202 side of the base member 200 (the first surface 102 of the substrate 100). Thus, the light from the light emitting element 140 is emitted toward outside the vehicle.

### EXAMPLE

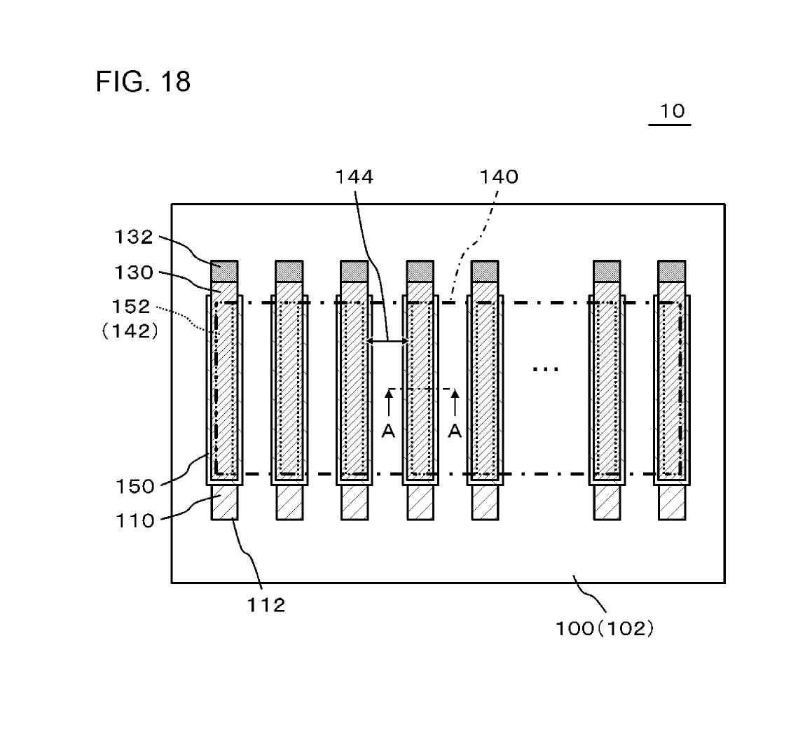

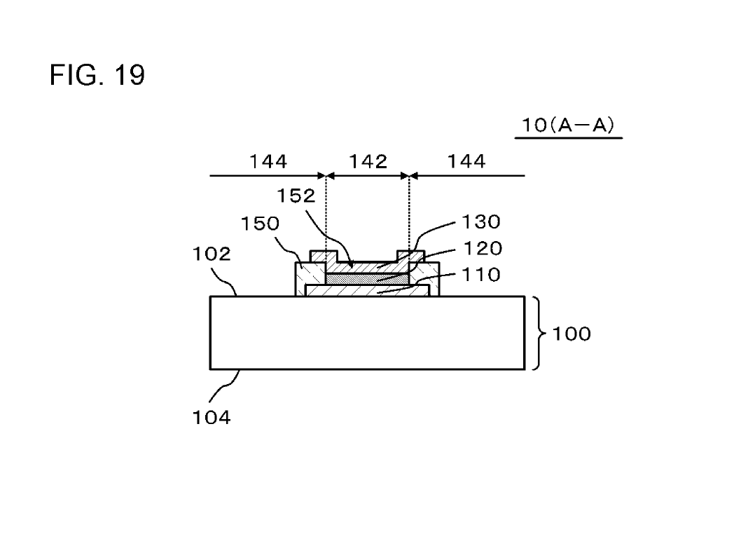

FIG. 18 is a plan view illustrating a light emitting device 10 used in a light emitting system according to an example. FIG. 19 is a cross-sectional view taken along line A-A of FIG. 18. The light emitting device 10 according to the present example includes a substrate 100, a first electrode 110, a first terminal 112, an organic layer 120, a second electrode 130, a second terminal 132, and an insulating layer 150.

The substrate 100 has a first surface 102 and a second surface 104. The second surface 104 is opposite to the first surface 102. The substrate 100 is formed of an insulating material having a light transmitting property, and specifically, a glass substrate, for example.

The first electrode 110 is on the first surface 102 of the substrate 100. In the example shown in FIG. 18, a plurality of first electrodes 110 is arranged in a row. Each first electrode 110 extends in a longitudinal direction in a direction intersecting (specifically, orthogonal to) the row direction of the plurality of first electrodes 110. The first electrode 110 is formed of a conductive material having a light transmitting property and is formed of, for example, a material containing a metal such as a metal oxide, and more specifically indium tin oxide (ITO), indium zinc oxide (IZO), indium tungsten zinc oxide (IWZO) or zinc oxide (ZnO), for example.

The first terminal 112 is connected to one end of the first electrode 110. A voltage from the outside may be applied to the first electrode 110 through the first terminal 112.

The insulating layer 150 is on the first surface 102 of the first electrode 110 and the substrate 100. In the example shown in FIG. 18, a plurality of insulating layers 150 is arranged in a row. The insulating layer 150 is formed of an organic insulating material such as polyimide. The insulating layer 150 has an opening 152 exposing a portion of the first electrode 110. That is, the light emitting portion 142 is defined by the opening 152 of the insulating layer 150.

The organic layer 120 is located within the opening 152 of the insulating layer 150 on the first electrode 110. In the example shown in FIG. 18, a plurality of organic layers 120 is arranged in a row. The organic layer 120 emits light by the voltage between the first electrode 110 and the second electrode 130. Specifically, the organic layer 120 includes, for example, a hole injection layer, a hole transport layer, a light emitting layer, an electron transport layer, and an electron injection layer. In this case, the hole injection layer and the hole transport layer are connected to the first electrode 110, and the electron injection layer and the electron transport layer are connected to the second electrode 130. One of the hole injection layer and the hole transport layer may be eliminated. One of the electron injection layer and the electron transport layer may be eliminated.

The second electrode 130 is on the organic layer 120 and the insulating layer 150. In the example shown in FIG. 18, a plurality of second electrodes 130 is arranged in a row. Each second electrode 130 extends in a longitudinal direction in a direction intersecting (specifically, orthogonal to) the row direction of the plurality of second electrodes 130. The second electrode 130 is formed of a light reflecting material such as metal. More specifically, the second electrode 130 includes a metal selected from the first group consisting of Al, Au, Ag, Pt, Mg, Sn, Zn, and In, or an alloy of metals selected from the first group. Accordingly, the light from the organic layer 120 does not transmit through the second electrode 130, and is emitted from the second surface 104 side of the substrate 100 through the first electrode 110. A part of the second electrode 130 overlaps with the opening 152 of the insulating layer 150.

The second terminal 132 is connected to one end of the second electrode 130. The second terminal 132 is opposite to the first terminal 112 across the light emitting portion 142. A voltage from the outside may be applied to the second electrode 130 through the second terminal 132.

In this embodiment, in general, the organic layer 120 is easily degraded by heat. Accordingly, when the organic layer 120 (that is, the light emitting portion 142) is located in the vicinity of the member that generates heat, the light emitting portion 142 is likely to be degraded. In contrast, in the example shown in FIGS. 1 to 3, the light emitting portion 142 (organic layer 120) does not overlap with the heating wire 300 in the thickness direction of the base member 200. Accordingly, the degradation of the organic layer 120 (light emitting portion 142) caused by the heating wire 300 can be reduced.

Although the embodiments and examples have been described with reference to the drawings, these are examples of the present invention, and various configurations other than those described above may also be adopted.

1. A light emitting system comprising:
a base member having a light transmitting property;
a first heating wire over a surface of or inside the base member; and
a first light emitting element over the surface of or inside the base member, the first light emitting element including a light emitting portion and a light transmitting portion,
wherein the light emitting portion does not overlap with the first heating wire in a thickness direction of the base member.

2. The light emitting system according to claim 1,
wherein the surface of the base member includes a first surface and a second surface opposite to the first surface, and
both the first heating wire and the light emitting portion are over the first surface or over the second surface.

3. The light emitting system according to claim 1,
wherein the base member includes a first base member having a first surface which is a part of the surface and a second surface opposite to the first surface, and a second base member having a third surface which is another part of the surface and a fourth surface opposite to the third surface,
the second surface of the first base member and the fourth surface of the second base member face each other, and
the first heating wire and the light emitting portion are between the second surface and the fourth surface.

4. The light emitting system according to claim 1,
wherein the light emitting portion includes an organic layer.

5. The light emitting system according to claim 1, further comprising:
a second heating wire adjacent to the first heating wire over the surface of or inside the base member,
wherein the first light emitting element includes a plurality of the light emitting portions arranged in a direction intersecting a direction from the first heating wire side to the second heating wire side.

6. The light emitting system according to claim 1, further comprising:
a second heating wire adjacent to the first heating wire over the surface of or inside the base member,
wherein the first light emitting element includes a plurality of the light emitting portions arranged in a direction from the first heating wire side to the second heating wire side.

7. The light emitting system according to claim 5,
wherein the plurality of light emitting portions is between the first heating wire and the second heating wire.

8. The light emitting system according to claim 1, further comprising:
a second light emitting element adjacent to the first light emitting element over the surface of or inside base member, the second light emitting element including a light emitting portion and a light transmitting portion,
wherein the first heating wire is between the first light emitting element and the second light emitting element.

9. The light emitting system according to claim 1,
wherein the base member is mounted over a moving object, and
light from the first light emitting element is emitted toward outside the moving object.

10. A light emitting system comprising:
a base member having a light transmitting property;
a first heating wire over a surface of or inside the base member;
a second heating wire adjacent to the first heating wire over the surface of or inside the base member; and
a first light emitting element over the surface of or inside the base member, the first light emitting element including a light emitting portion and a light transmitting portion,
wherein the light emitting portion is between the first heating wire and the second heating wire, and does not overlap with the first heating wire and the second heating wire in a thickness direction of the base member.

11. A method of attaching a light emitting device including a light emitting portion and a light transmitting portion to a light-transmitting base member including a first heating wire, the method comprising:
attaching the light emitting device to the base member such that the light emitting portion and the first heating wire do not overlap with each other in a thickness direction of the base member.
